(19) United States
(12) Patent Application Publication
(10) Pub. No.: US 2011/0218865 A1
(43) Pub. Date: Sep. 8, 2011

(54) Bandwidth Constrained Auctions

(75) Inventors: Shanmugavelayutham Muthukrishnan, New York, NY (US); Tanmoy Chakraborty, Philadelphia, PA (US); Eyal Even-Dar, New York, NY (US); Yishay Mansour, Tel Aviv (IL)

(73) Assignee: GOOGLE INC., Mountain View, CA (US)

(21) Appl. No.: 13/016,035

(22) Filed: Jan. 28, 2011

Related U.S. Application Data
(60) Provisional application No. 61/299,604, filed on Jan. 29, 2010.

(51) Int. Cl. G06Q 30/00

(52) U.S. Cl. 705/14.71

(57) ABSTRACT

Methods, systems, and apparatus, including computer programs encoded on a computer storage medium, for selectively requesting bids from content item providers. In one aspect, a method includes selecting eligible content item providers that are eligible to respond to a next content request. Each of the eligible content item providers can be selected based, at least in part, on a response constraint that specifies a maximum rate at which the content item provider is able to receive content requests. Impression likelihood scores are determined for the eligible content item providers, and qualified content item providers are selected a set of the eligible content item providers are selected as qualified content item providers based on the impression likelihood scores. The impression likelihood score for each qualified content item provider meets a threshold impression likelihood score. The next content request is received, and bids are requested from the qualified content item providers in response to the request. A content item from at least one of the qualified content item providers is provided.

### CROSS-REFERENCE TO RELATED APPLICATIONS

This application claims the benefit under 35 U.S.C. §119(e) of U.S. Patent Application No. 61/299,604, entitled “Selective Call Out In Bandwidth-Constrained Auctions,” filed Jan. 29, 2010, which is incorporated herein by reference in its entirety.

### BACKGROUND

This specification relates to data processing and content item selection. The Internet provides access to a wide variety of resources. For example, video and/or audio files, as well as web pages for particular subjects or that present particular news articles are accessible over the Internet. Access to these resources presents opportunities for advertisements (or other sponsored content items) to be provided with the resources. For example, a web page can include “slots” (i.e., pre-defined portions of the web page) in which advertisements (or other content items) can be presented. These slots can be defined in the web page or defined for presentation with a web page, for example, in a pop-up window.

Content items that are presented in slots of a resource are selected for presentation by a content distribution system. The content distribution system receives content requests for content items (e.g., advertisements, video, audio or other content items) to be provided with a resource and selects a content item provider to provide a content item in response to the request. As described in more detail below, the content distribution system can be in communication with many different content item providers (e.g., advertising networks) that can each provide a content item that is responsive to the request. The content distribution system conducts an auction to select the content item provider that will provide a content item in response to the request. For example, when the content distribution system receives a content request, the content distribution system can provide information about the content request to each of the various content item providers. In turn, the content distribution system can request that each of the content item providers submit information about the content item that would be provided by the content item provider (“proposed content item”) and a bid specifying a maximum amount to be paid by the content item provider for distribution of the proposed content item. Using the bids that are received from the content item providers, the content distribution system selects a winning content item provider to provide a content item in response to the request.

As the quantity of content requests that are received by the content distribution system increases, the computing resources required to service the requests increases. For example, if 1,000,000 content requests are received each minute, the content distribution system must request bids from the content item providers 1,000,000 times a minute. Some or all of the content item providers may be implemented in different computing apparatus than the content distribution system and/or each have different computing resources. Therefore, one or more of the content item providers may not have sufficient computing resources to respond to every bid.

### SUMMARY

In general, one innovative aspect of the subject matter described in this specification can be embodied in methods that include the actions of selecting eligible content item providers that are eligible to respond to a next content request, each of the eligible content item providers being selected based, at least in part, on a response constraint that specifies a maximum rate at which the content item provider is able to receive content requests; determining impression likelihood scores for the eligible content item providers, the impression likelihood score for each of the eligible content item providers specifying a likelihood that a bid received from the eligible content item provider will be a winning bid for the request; selecting, as qualified content item providers, a set of the eligible content item providers, each of the qualified content item providers having an impression likelihood score that meets a threshold impression likelihood score; receiving the next content request that requests a content item to be provided with an online resource; requesting bids from the qualified content item providers in response to the request; and providing a content item from at least one of the qualified content item providers, the provided content items being selected based, at least in part, on the bids that have been received in response to the request. Other embodiments of this aspect include corresponding systems, apparatus, and computer programs, configured to perform the actions of the methods, encoded on computer storage devices.

These and other embodiments can each optionally include one or more of the following features. Selecting the eligible content item providers can include selecting advertising networks that are eligible to respond to a next advertisement request based, at least in part, on a response constraint that specifies a maximum rate at which the content item provider is able to respond to advertisement requests; and receiving the next content request comprises receiving the next advertisement request that requests an advertisement to be provided with the online resource.

Selecting eligible content item providers can further include receiving, for each content provider, constraint data specifying the response constraint for the content item provider; determining, for each content provider, an actual rate at which bids have previously been requested from the content item provider; and selecting, for each content provider, the content item provider as an eligible content item provider when the actual rate is less than the maximum rate specified by the response constraint.

Methods can further include the action of determining a threshold impression likelihood score specifying an impression likelihood score at which a benefit to the content item provider of receiving a bid request for the next content request is substantially equal to an opportunity cost of utilizing bandwidth and other processing resources to process the bid request. Determining a threshold impression likelihood score can include determining a different threshold impression likelihood score for each of the qualified content item providers. Determining an impression likelihood score can include determining a different impression likelihood score for each of a plurality of different targeting criteria.

The impression likelihood score can be determined for each content item provider based on a function of bid values and a success probability. Methods can further include the actions of receiving, for each content item provider, historical bid data that specify a bid value distribution for bids that have been received from the content item provider; receiving, for each content item provider, a winning bid value distribution specifying likelihoods that bid values will be winning bid values; and determining, for each content item provider, a success probability based on a function of the bid value distribution and the winning bid value.

Determining the impression likelihood scores can include determining, for each content item provider, the impression likelihood score for the content item provider based on the success probability and the bid value distribution. Determining the impression likelihood scores can include determining the impression likelihood scores on a per-targeting-criterion basis.

Providing a content item from at least one of the qualified content item providers can include the actions of receiving bids from the qualified content item providers; computing auction scores for the qualified content item providers from which bids were received; and selecting at least one winning content item provider based on the auction scores.

Particular embodiments of the subject matter described in this specification can be implemented so as to realize one or more of the following advantages. A computer can be configured to increase the likelihood that bandwidth constraints of other computer systems with which the computer communicates are not exceeded. For example, the rate at which the other computer systems are requested to respond to bid requests can be limited to reduce the likelihood that bid requests fail to be processed by the other computer systems. The likelihood that a particular computer system responds to a bid request can be increased by selectively sending bid requests to the particular computer system based on the maximum rate at which the particular computer system can process and/or respond to bid request.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which content items are distributed by a content distribution system.

FIG. 2 is a block diagram of an example data flow for selectively requesting bids from advertising networks.

FIG. 3 is a flow chart of an example process for selectively requesting bids from content item providers.

FIG. 4 is block diagram of an example computer system that can be used to selectively request bids from content item providers.

Like reference numbers and designations in the various drawings indicate like elements.

### DETAILED DESCRIPTION

A content distribution system selectively requests bids from content item providers so that the rate at which each different content item provider is requested to provide a bid is within a maximum rate at which the content item provider is able to respond to requests (e.g., based on available computing resources of the content item provider). For example, the content distribution system can monitor, for each content item provider, an actual rate at which the content distributor has provided bids, and compare this actual rate to a maximum rate at which the content item provider can respond (e.g., as specified by the content item provider or as determined by an analysis historical data). If the actual rate is less than (or equal to) the maximum rate, the content item provider is included in a set of eligible content item providers that are eligible (e.g., based on available computing resources) to provide bids in response to the request.

The content distribution system determines impression likelihood scores for each content item provider in the set of the eligible content item providers. The impression likelihood score for each content item provider specifies a likelihood that a bid that is provided by the content item provider will be a winning bid (e.g., based on historical bid data). The content distribution system uses the impression likelihood scores to select a set of the eligible content item providers as qualified content item providers. In turn, the content distribution system requests bids from the qualified content providers, selects a winning bid, and provides a content item from the content item provider that submitted the winning bid.

The description that follows describes the content distribution system as an advertisement distribution system that distributes advertisements for two or more different advertising networks (i.e., content item providers that provide advertisements). The apparatus and methods discussed below can also be used to facilitate selection and delivery of other content items in response to content requests.

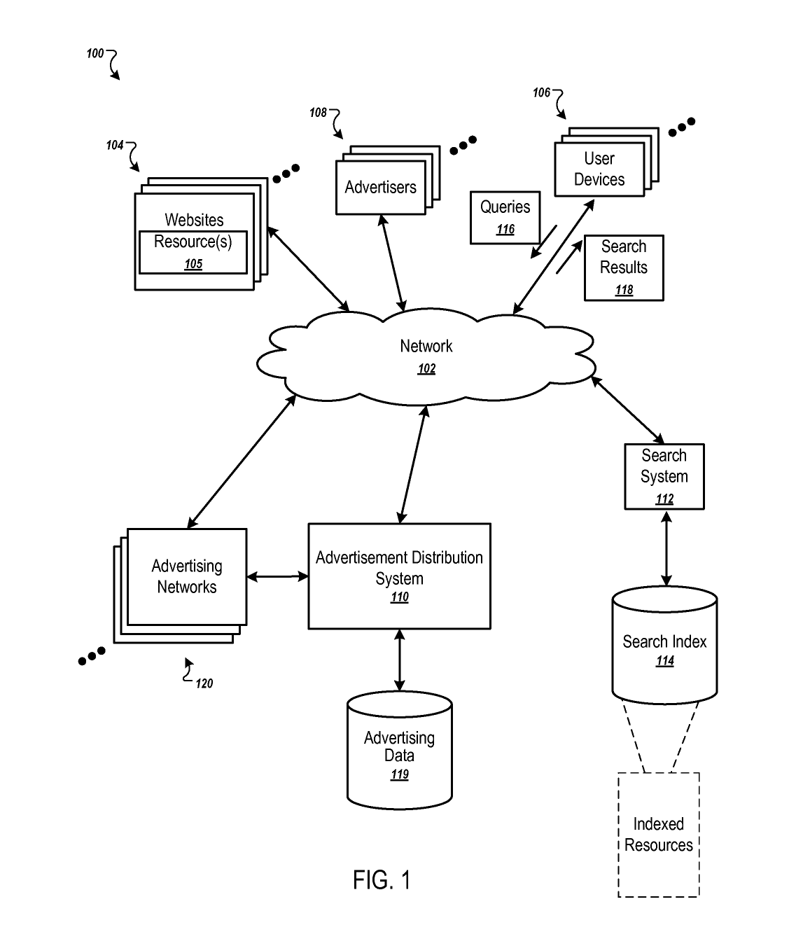

FIG. 1 is a block diagram of an example environment 100 in which content items are distributed by a content distribution system. For example, the environment 100 includes an advertisement distribution system 110 that manages advertising services. The example environment 100 also includes a network 102, such as a local area network (LAN), a wide area network (WAN), the Internet, or a combination thereof. The network 102 connects websites 104, user devices 106, advertisers 108, and the advertisement distribution system 110. The example environment 100 may include many thousands of websites 104, user devices 106, and advertisers 108.

A website 104 is one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a publisher, which is an entity that controls, manages and/or owns the website 104.

A resource 105 is any data that can be provided over the network 102. A resource 105 is identified by a resource address that is associated with the resource 105. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as JavaScript scripts).

A user device 106 is an electronic device that is under control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display (e.g., a presentation location of a pop-up window or in a specified area of a web page) in which advertisements can be presented. These specified portions of the resource or user display are referred to as content item slots or advertisement slots.

To facilitate searching of these resources 105, the environment 100 can include a search system 112 that identifies the resources 105 by crawling and indexing the resources 105 provided by the publishers on the websites 104. Data about the resources can be indexed based on the resource 105 to which the data corresponds. The indexed and, optionally, cached copies of the resources 105 are stored in a search index 114.

User devices 106 can submit search queries 116 to the search system 112 over the network 102. In response, the search system 112 accesses the search index 114 to identify resources that are relevant to the search query 116. The search system 112 identifies the resources in the form of search results 118 and returns the search results 118 to the user devices 106 in search results pages. A search result 118 is data generated by the search system 112 that identifies a resource that is responsive to a particular search query, and includes a link to the resource. An example search result 118 can include a web page title, a snippet of text or a portion of an image extracted from the web page, and the URL of the web page. Search results pages can also include one or more advertisement slots in which advertisements can be presented.

When a resource 105 or search results 118 are requested by a user device 106, the advertisement distribution system 110 receives a request (i.e., a content request) for advertisements to be provided with the resource 105 or search results 118. The request for advertisements can include characteristics of the advertisement slots that are defined for the requested resource or search results page, and can be provided to the advertisement distribution system 110. For example, a reference (e.g., URL) to the resource (e.g., a retailer's web page or a web page for a sports network) for which the advertisement slot is defined, a size of the advertisement slot, and/or media types that are available for presentation in the advertisement slot can be provided to the advertisement distribution system 110. Similarly, keywords associated with a requested resource (“resource keywords”) or a search query 116 for which search results are requested can also be provided to the advertisement distribution system 110 to facilitate identification of advertisements that are relevant to the resource or search query 116.

The advertisement distribution system 110 is configured to interact with two or more advertising networks 120 that can provide advertisements in response to a content request. As described in more detail below, the advertisement distribution system 110 can selectively transmit a bid request to a portion (e.g., a proper subset of or all) of the advertising networks 120. In some implementations, the bid request provides the advertising networks 120 information about the content request and requests that the advertising networks to submit bids to compete for the opportunity to provide an advertisement in response to the content request. The bid request can include targeting criteria, such as resource keywords for the resource with which the selected advertisement will be provided, demographic and/or psychographic information about the user to whom the advertisement will be presented, and/or characteristics of the advertisement slot in which the advertisement will be provided.

Based on the information included in the bid request, each of the advertising networks 120 can select advertisements that are eligible to be provided in response to the request (“eligible advertisements”). Eligible advertisements can include, for example, advertisements having characteristics matching the characteristics of advertisement slots and that are identified as relevant to specified resource keywords or search queries 116. In some implementations, advertisements having targeting keywords that match the resource keywords (or other targeting criteria) or the search query 116 are selected as eligible advertisements by the advertisement distribution system 110.

A targeting keyword can match a resource keyword or a search query 116 by having the same textual content (“text”) as the resource keyword or search query 116. The relevance can be based on root stemming, semantic matching, and topic matching. For example, an advertisement associated with the targeting keyword “hockey” can be an eligible advertisement for an advertisement request including the resource keyword “hockey.” Similarly, the advertisement can be selected as an eligible advertisement for an advertisement request including the search query “hockey.”

A targeting keyword can also match a resource keyword or a search query 116 by having text that is identified as being relevant to a targeting keyword or search query 116 despite having different text than the targeting keyword. For example, an advertisement having the targeting keyword “hockey” may also be selected as an eligible advertisement for an advertisement request including a resource keyword or search query for “sports” because hockey is a type of sport, and therefore, is likely to be relevant to the term “sports.”

Information about the content requests that are received can be stored in the advertising data store 119. For example, the time at which each content request is received as well as targeting information that was specified by the content request can be indexed according to the resource for which the content request was submitted. The advertising data store can also store performance measures (e.g., click-through-rates) for content items that were provided in response to the content requests.

The advertisement distribution system 110 can select the advertising network 120 that will provide an advertisement for presentation in response to the content request based on results of an auction. In some implementations, the advertisement distribution system 110 receives, from one or more of the advertising networks 120, a bid specifying a maximum amount to be paid for distribution of the advertisement that is provided by the advertising network. For example, advertising network A may submit a bid of $1.00 specifying that up to $1.00 will be paid for distribution of the advertisement that is provided by advertising network A. Similarly, advertising network B may submit a bid of $0.80 specifying that up to $0.80 will be paid for distribution of the advertisement provided by advertising network B.

The auction winner can be determined based on “auction scores.” An auction score is a value based, in part, on a bid that is received from advertising network 120. In some implementations, each auction score can represent a bid, or a product (or another function) of the bid and one or more factors, such as a quality score associated with the advertising network. For example, the quality score can be derived from one or more of advertisement performance measures (e.g., based on advertisement click-through-rates), advertisement content quality factors (e.g., user feedback, color, animation, and other aspects of the advertisement's appearance), and/or landing page scores.

For example, assume that the auction score is a product of the bid specified by the advertiser and a quality score for the advertising network (i.e., auction score=bid*advertising network quality score). Further assume that advertising network A selects a $1.00 bid for the content request and has a quality score of 5.0, while advertising network B selects a $0.80 CPC bid for the content request and has a quality score of 9.0. In this example, advertising network A will have an auction score of 5.0, while advertising network B will have an auction score of 7.2. Thus, advertising network B will have the winning bid in this example, even though advertising network A submitted the higher bid.

The advertisement distribution system 110 can request bids from advertising networks on a per-content request basis, such that the advertisement distribution system is configured to transmit bid requests at the same rate at which content requests are received. However, some of the advertising networks may not have the computing resources required to receive and/or respond to bid requests for every content request. As described in more detail below, the advertisement distribution system 110 is configured to selectively transmit bid requests to those advertising networks that have available computing resources to receive and respond to the bid request and/or those advertising networks that have at least a threshold likelihood of providing the winning bid in response to the current bid request.

In some implementations, the advertisement distribution system 110 identifies, on a per-request basis, a set of eligible advertising networks that are capable of processing a bid request. The set of eligible advertising networks can be selected based on an actual number of bid requests that have been provided to each of the advertising networks over a specified time period (i.e., an actual rate) relative to a maximum number of bid requests that each of the advertising networks is capable of receiving and/or processing over the specified time period (e.g., as specified by the advertising network). For example, the set of eligible advertising networks can include those advertising networks for which the actual number of bid requests over the specified time period is less than or equal to the maximum number of bid requests for the specified time period.

Once the set of eligible advertising networks has been identified, the advertisement distribution system 110 can determine which of the eligible advertising networks is a qualified advertising network. A qualified advertising network is an advertising network that has at least a threshold likelihood of providing the winning bid in response to the bid request. The likelihood that an advertising network will provide the winning bid can be represented, for example, based on an impression likelihood score, as described in more detail below.

The advertisement distribution system 110 transmits bid requests to the qualified advertising networks, and receives bids from at least a portion of the qualified advertising networks. Using the bids, the advertisement distribution system 110 selects the advertising network that submitted the winning bid, and a content item from the winning advertising network is provided in response to the content request.

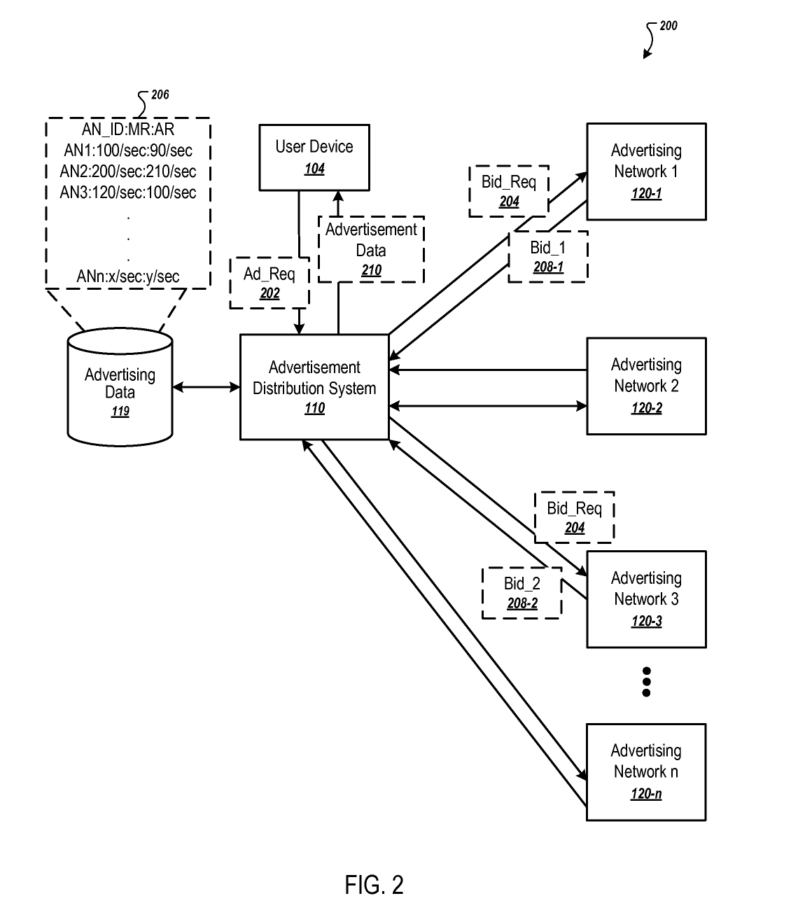

FIG. 2 is a block diagram of an example data flow 200 for selectively requesting bids from advertising networks. Prior to receiving an advertisement request (Ad_Req) 202, the advertisement distribution system 110 pre-determines to which of the advertising networks a bid request (Bid_Req) 204 will be sent. In some implementations, the advertisement distribution system 110 selects the advertising networks that will receive the bid request 204 based, in part, on the actual rate at which bids are being requested from each of the advertising networks and the maximum respective rate at which each advertising network is able to receive and/or process bid requests.

For example, the advertisement distribution system 110 can obtain rate data 206 from the advertising data store 119. The rate data 206 are data that specify an advertising network identifier (AN_ID), a maximum rate (MR) at which an advertising network is able to receive and/or process bid requests, and an actual rate (AR) at which the advertising network has previously been requested (e.g., over the specified period) to provide bids.

Using the rate data 206, the advertisement distribution system 110 determines which advertising networks are eligible advertising networks. An eligible advertising network is an advertising network having an actual rate that is less than or equal to the maximum rate for the advertising network. The actual rate for an advertising network can be determined, for example, based on a number of bid requests to which the advertising network has responded over a specified period of time. The actual rate can be an instantaneous rate (e.g., over a single period of time), an average rate over multiple periods of time, or another measure of central tendency over multiple periods of time. The eligible advertising networks can be identified based on a comparison of the actual rate and the maximum rate for the advertising network.

Using the rate data 206 of FIG. 2, the advertising distribution system 110 will determine that advertising network 1 (AN1) 120-1 and advertising network 3 (AN3) 120-3 are eligible advertising networks, while advertising network 2 (AN2) 120-2 is not an eligible advertising network. In this example, advertising network 1 120-1 is an eligible advertising network because advertising network 1 120-1 has a maximum rate of 100 bid requests per second, while the actual rate for advertising network 1 120-1 is 90 bid requests per second. Thus, advertising network 1 120-1 has additional bandwidth to process and/or respond to additional bid requests. Similarly, the advertisement distribution system 110 will determine that advertising network 3 120-3 is also an eligible advertising network because advertising network 3 120-3 the maximum rate for advertising network 3 120-3 is 120 bid requests per second, while the actual rate for advertising network 3 120-3 is 100 bid requests per second. However, in this example, the advertisement distribution system 110 will determine that advertising network 2 (AN2) 120-2 is not able to receive and/or process additional bid requests because the actual rate for advertising network 2 120-2 is 210 bid requests per second, while the maximum rate is 200 bid requests per second. Thus, the actual rate for advertising network 2 120-2 is greater than the maximum rate.

In some implementations, the advertisement distribution system 110 can a transmit bid request 204 to each of the eligible advertising networks. Continuing with the example above, advertisement distribution system 110 can transmit a bid request 204 to advertising network 1 120-1 and advertising network 2 120-3, since each of these advertising networks is an eligible advertising network.

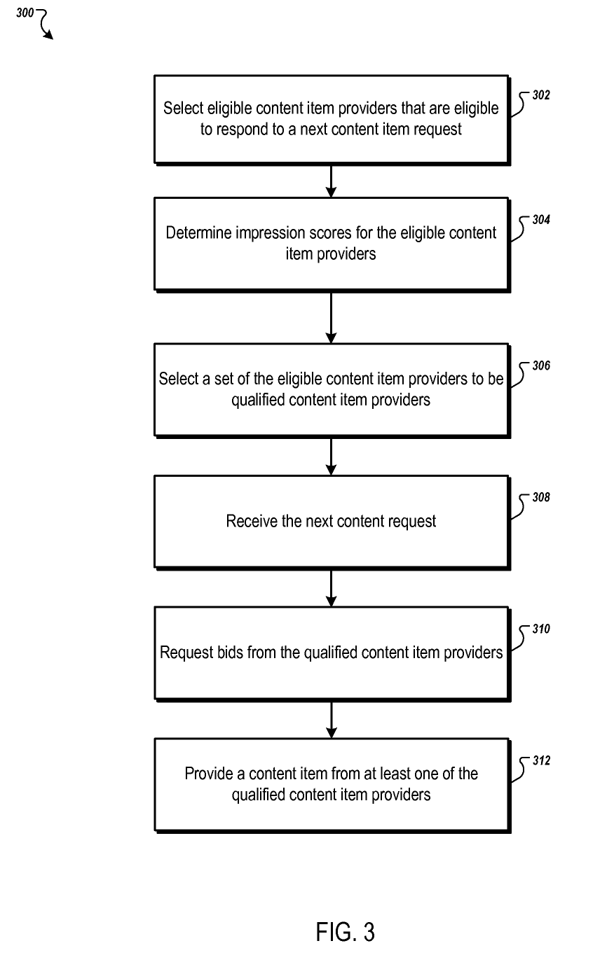

In some implementations, the advertisement distribution system 110 can selectively send a bid request 204 only to the eligible advertising networks that are also qualified advertising networks. For example, as described in more detail with reference to FIG. 3, the advertisement distribution network 110 can determine, for each of the eligible advertising networks, an impression likelihood score that specifies a likelihood that the advertising network will provide a winning bid in response to the next bid request. The advertisement distribution system 110 compares the impression likelihood scores to a threshold impression likelihood score, and selects qualified advertising networks based on the comparison. In turn, the advertisement distribution network 110 can limit transmission of the bid request 204 to the qualified advertising networks.

As described in more detail below, impression likelihood scores can be determined on a per-targeting-criterion basis so that when a particular advertising network prefers (e.g., based on historical bids or explicit preference data) a particular type of impression (e.g., an impression that matches particular targeting criteria) more than other impression types, the particular advertising network will be more likely to receive more bid requests for the preferred impression types over the other impression types. Using impression likelihood scores to selectively transmit bid requests to advertising networks can result in a more efficient use of each advertising network's available bandwidth because the advertising networks are less likely to be processing bid requests that are of low value to the advertising network (e.g., based on historical bid data).

The advertisement distribution system 110 receives, from at least a portion of the advertising networks, bid data 208 that specify a maximum amount (i.e., a maximum bid) that the advertising network will pay for the opportunity to provide an advertisement in response to the advertisement request 202. The amounts specified in the bid data 208 can be expressed as cost-per-click (CPC) or other cost-per-action (e.g., cost-per-conversion) amounts. Alternatively, the amounts specified in the bid data can be a maximum amount for distribution of the advertisement without any requirement that a user take action (e.g., a cost-per-impression).

Continuing with the example above, the advertisement distribution system 110 may receive bid data 208-1 (Bid_1) from advertising network 1 120-1 in response to the bid request 204. The bid data 208-1 may specify, for example that advertising network 1 is willing to pay $1.00 CPC for the opportunity to provide an advertisement in response to the advertisement request 202. The advertisement distribution system 110 may also receive bid data 208-2 (Bid_2) from advertising network 3 120-3. The bid data 208-2 may specify that advertising network 3 120-3 is willing to pay $1.25 CPC for the opportunity to provide an advertisement in response to the advertisement request 202.

Using the amounts specified by the bid data 208 alone, or in combination with other data such as advertising network quality scores, the advertisement distribution system 110 selects a winning advertisement network (i.e., the advertising network that provided the winning bid). For example, assume that the advertising data store 119 includes quality scores of 0.9 and 0.6 (on a 1.0 scale) for advertising network 1 120-1 and advertising network 3 120-3, respectively. In this example, the advertisement distribution system 110 can compute auction scores for the advertising networks use the bid data 208 and quality scores. For example, the advertisement distribution system 110 can determine that advertising network 1 120-1 has an auction score of 0.9 (i.e., 1.00*0.9) and that advertising network 3 120-3 has an auction score of 0.6 (i.e., 1.25*0.6). In this example, the advertisement distribution system 110 can select advertising network 3 120-3 as the winning advertising network, and provide advertisement data 210 (e.g., a URL to an advertisement server of advertising network 3 120-3) to the user device 104.

FIG. 3 is a flow chart of an example process 300 for selectively requesting bids from content item providers. The process 300 is a process by which eligible content item providers are selected based on a comparison of actual rates at which content item providers have responded to bid requests relative to maximum rates at which the content item providers are able to respond to bid requests. An impression likelihood score is determined for each of the eligible content item providers, and a set (e.g., a proper subset) of the eligible content item providers is selected as qualified content items. When the next content request is received, bids are requested from the qualified content item providers, and a content item from at least one of the content item providers is provided.

The process 300 can be implemented, for example, by the advertisement distribution system 110 of FIG. 1. In some implementations, the advertisement distribution system 110 is a data processing apparatus that includes one or more processors that are configured to perform actions of the process 300. In some implementations, a computer readable medium can include instructions that when executed by a computer cause the computer to perform actions of the process 300.

Eligible content item providers are selected (302). In some implementations, the eligible content item providers are content item providers (e.g., advertising networks) that are eligible to respond to a next content request. For example, as described with reference to FIG. 2, the eligible content item providers can be content item providers for which the actual rate at which the content item provider has responded to bid requests (e.g., over a specified period) is less than or equal to a maximum rate at which the content item provider has indicated that it is able to respond to bid requests.

In some implementations, the maximum rate at which a particular content item provider is able to respond to bid requests is specified in constraint data that are received from the content item provider. For example, a content item distribution system (e.g., an advertisement distribution system) can receive from each content item provider (e.g., advertising network) constraint data that specify the maximum rate at which the content item provider can process and/or respond to bid requests (or other requests). In turn, the content item distribution system can store the constraint data in a data store in association with (i.e., indexed according to or stored with a reference to) the advertising network from which the constraint data were received.

In some implementations, the actual rate at which bids have previously been requested from a particular content item provider is determined based on historical bid request data. For example, for each content item provider, a content item distribution system can store call-out data specifying each bid request that was provided to the content item provider, and times at which each bid request was provided to the content item provider. In turn, the call-out data can be used to determine the rate at which the content item provider has been provided a bid request. For example, the content item distribution system can determine a quantity of bid requests that a particular content item provider was provided over a specified period of time (e.g., a second, a minute, or an hour).

Once the actual rate for a content item provider is known, the actual rate can be compared to the maximum rate specified by the constraint data. If the actual rate for the particular content item provider is less than or equal to (i.e., does not exceed) the maximum rate, the content item provider can be selected as an eligible content item provider. If the actual rate for the particular content item provider exceeds the maximum rate, the content item provider may not be selected as an eligible content item provider.

An impression likelihood score is determined for each of the eligible content item providers (304). In some implementations, the impression likelihood score specifies a likelihood that the content item provider will submit a winning bid in response to the next bid request. The impression likelihood score can be determined, for example, based on historical bid data. Historical bid data for a particular content item provider can specify a bid value distribution for bids that have been received from the particular content item provider.

The bid value distribution can specify, for example, a relative likelihood that a particular content item provider will submit a bid having a particular value. For example, if the bid value distribution for a particular content item provider has a normal (i.e., Gaussian) distribution, then approximately 68% of the bids received from the content item provider specified values that are within one standard deviation of the mean bid value for bids that have been received from the content item provider. Table 1 provides an example bid value distribution for a content item provider.

TABLE 1

| Bid Value | Percentage of Total Bids |
|---|---|
| $1.00 | 10 |
| $1.20 | 15 |
| $1.30 | 25 |
| $1.40 | 25 |
| $1.50 | 15 |
| $1.60 | 10 |

The relative likelihood of each bid value being submitted by the content item provider can be expressed as a percentage of the total bids that have been received from the content item provider and have the bid value. For example, according to Table 1, the relative likelihood of receiving bid of $1.30 is 25%, indicating that 25% of the bids that have been received from the content item provider have specified the value $1.30.

In some implementations, the impression likelihood score for a particular content item provider is computed using each bid value in the bid value distribution, the relative likelihoods that each of the bid values is received, and a success probability for each of the bid values. For example, the impression likelihood score can be computed using relationship 1

ISᵢ=Σᵥvyᵢⱼᵥ (1)

where,

ISᵢ is the impression likelihood score for content item provider (i);

v is the bid value; and

yᵢⱼᵥ is the success probability for the bid value (v).

The success probability for the bid value (v) specifies a likelihood that content item provider (i) submits the bid value (v) and is selected as the winning content item provider for the next content request (j). The success probability can be determined as a function of the historical bid data. For example, the success probability can be a function (e.g., a product) of the likelihood that content item provider (i) submits the bid value (v) and the likelihood that the bid value (v) is the winning bid.

As described above, the likelihood that content item provider (i) submits the bid value (v) can be determined using the bid value distribution (e.g., from Table 1) for the content item provider. The likelihood that the bid value (v) will be the winning bid can be determined based on statistical analysis (e.g., using machine learning techniques such as regression analysis) of bid values for previous winning bids. Table 2 provides an example winning bid distribution that can be stored in a data store such as the advertising data store 119 of FIG. 1. The winning bid distribution of Table 2 specifies, for each bid value, a percentage of all content requests for which the bid value would have been the winning bid.

TABLE 2

| Winning | Percentage of Total Content |
|---|---|
| Bid Value | requests |
| $1.00 | 10 |
| $1.20 | 15 |
| $1.30 | 25 |
| $1.40 | 35 |
| $1.50 | 85 |
| $1.60 | 100 |

Using the bid value distribution of Table 1, the winning bid value distribution of Table 2 and relationship (1), the impression likelihood score for content item provider (i) can be computed as illustrated in Table 3.

TABLE 3

| | Success Probability (SPᵥ) = | |
|---|---|---|
| | (Percentage of Total Bids having | Impression |
| | Bid value) * (Percentage of Total | likelihood |
| | Content requests for which (v) is | scoreᵥ = |
| Bid Value (v) | Winning Bid) | (v * SPᵥ) |
| $1.00 | 0.01 | 0.01 |
| | (0.1 * 0.1) | (1.00 * 0.01) |
| $1.20 | 0.0225 | 0.027 |
| | (0.15 * 0.15) | (1.20 * 0.0225) |
| $1.30 | 0.0625 | 0.08125 |
| | (0.25 * 0.25) | (1.30 * 0.0625) |
| $1.40 | 0.0875 | 0.1225 |
| | (0.25 * 0.35) | (1.40 * 0.0875) |
| $1.50 | 0.1275 | 0.19125 |
| | (0.15 * 0.85) | (1.50 * 0.1275) |
| $1.60 | 0.10 | 0.16 |
| | (0.1 * 1.00) | (1.60 * 0.10) |
| ISᵢ = Σᵥ(v * SPᵥ) | | 0.592 |

Impression likelihood scores can be computed for each content item provider, and used to select qualified content item providers, as described below. In some implementations, impression likelihood scores are computed on a per-targeting-criterion basis. For example, bid value distributions and winning bid value distributions can be indexed according to one or more targeting criterion that were specified by the bid request in response to which the bids were provided. In turn, these indexed targeting criterion indexed distributions can each be used to compute, for each content provider, separate impressions scores based on the different targeting criteria that may be specified by the next content request and/or bid request.

Computing impression likelihood scores on a per-targeting-criterion basis (or set of targeting criterion) can increase the likelihood that content item providers receive bid requests to which the content item providers will respond. Using per-targeting-criterion impression likelihood scores can also result in more effective use of each content item provider's limited computing resources. For example, a particular content item provider may only be interested in submitting bids in response to bid requests specifying “sports” as a targeting criterion. If this “sports” targeting preference has not been explicitly specified by the content item provider, this targeting preference may be determined based on an analysis of the bid requests for which the content item provider has previously submitted bids and/or the value of those submitted bids.

For example, if the content item provider has only submitted bids in response to bid requests that specified the targeting criterion “sports,” despite having been provided bid requests that specified other targeting criterion, then it may be determined that the particular content item provider prefers “sports” targeted bid requests. Similarly, if the bids that were submitted by the particular content item provider in response to “sports” targeted bid requests were higher than the bids provided in response to bid requests that were not “sports” targeted, then it is likely that the content item provider prefers “sports” targeted bid requests.

In this example, using per-targeting-criterion impression likelihood scores may enable the particular content item provider to receive more bid requests for “sports” targeted bid requests than if a single impression likelihood score were used for each content item provider. For example, if the bids being submitted by the particular content item provider for “sports” targeted bid requests are relatively high (e.g., relative to other bids received in response to the “sports” targeted bid requests), then the impression likelihood score for the particular content item provider is likely to be relatively high, such that the particular content item provider may often be selected as a qualified content item provider for “sports” targeted content requests, and in turn, requested to submit a bid.

In some implementations, a bid request specifies that more than one content item is being requested for presentation with a single resource. For example, a web page may include three different advertisement slots in which advertisements (or other content items) can be presented. In this example, three different content item providers may be selected to be winning content item providers, with each of the different content item providers providing a different advertisement for presentation in one of the advertisement slots.

The performance (e.g., the click-through-rate or conversion rate) of content items can depend, in part, on the location of the web page in which the content item is presented. For example, content items that are presented at a banner position (e.g., top center) of the web page may have higher performance measures than content items that are presented at a lower-right-hand position of the web page. Therefore, content item providers may prefer more prominent page positions (e.g., banner positions) over less prominent page positions (e.g., lower page positions).

The preference for more prominent page positions over less prominent page positions can be used to compute impression likelihood scores for content item providers. For example, relationship (2) can be used to compute impression likelihood scores that are based, in part, on the quantity of requested content items.

ISᵢ=Σᵥαₗvyᵢⱼᵥₗ (2)

where,

ISᵢ is the impression likelihood score for content item provider (i);

v is the bid value;

αₗ is a discount factor for the content item slot (l); and

yᵢⱼᵥₗ is the success probability for the bid value (v) at content item slot (l).

The discount factor (α) for a content item slot (l) specifies a relative performance of content items that are presented in content item slot (l) of a web page. The relative performance can be determined relative to a reference content item slot. For example, the reference content item slot can be a content item slot at which content items that are presented with the web page have the highest performance measure (e.g., the highest median click-through-rate). The discount factor for each of the other content item slots on the web page can be computed, for example, as a ratio of the performance measure (e.g., median click-through-rate) for content items that are presented at the other content item slot relative to the highest performance measure. Discount factors for content item slots can be determined by an external data processing apparatus and stored in a data store such as the advertising data store 119 of FIG. 1 that is accessible by the advertisement distribution system.

In some implementations, the impression likelihood score for a particular content item provider can be computed as a function of the impression likelihood scores for each of the content item slots. For example, impression likelihood scores can be computed for each content item slot for which bids are being requested, and the sum of these impression likelihood scores for all (or a proper subset) of the content item slots can be used as the impression likelihood score for the content item provider when selecting qualified content item providers.

A set of the eligible content item providers is selected to be qualified content item providers (306). In some implementations, each of the qualified content item providers has an impression likelihood score that exceeds a threshold impression likelihood score. The threshold impression likelihood score is an impression likelihood score at which the benefit to the content item provider of receiving a bid request for the next content request is substantially equal to an opportunity cost of utilizing bandwidth and other processing resources to process the bid request. Thus, when the impression likelihood score is lower than the threshold impression likelihood score, the next content request is of low value to the content item provider, such that it may be more beneficial to the content item provider to not receive a bid request for the next content request rather than utilize limited computing resources processing the bid request. However, when the impression likelihood score exceeds the threshold impression likelihood score, the benefit of responding to the bid request is high enough to justify utilizing limited resources to do so.

In some implementations, a different threshold impression likelihood score is selected for each different content item provider (i.e., on a per-content-item-provider basis). For example, the threshold impression likelihood score for a particular content item provider can be selected based on a function of impression likelihood scores for the content item provider for particular types of content requests and the likelihood that a particular type of content request (e.g., requesting “sports” content) is the next content request that is received. Relationship (3) is an example linear program with which threshold impression likelihood scores can be selected.

ISTᵢ=max ΣⱼqⱼΣᵥΣₜαₜyᵢⱼᵥₗ (3)

such that:

Σⱼqⱼxᵢ≦pᵢ;

ΣvΣₜyᵢⱼᵥₗ≦1.0;

xᵢⱼ≦1.0;

Σₗyᵢⱼᵥₗ≦pᵢⱼᵥxᵢⱼ; and

xᵢⱼ,yᵢⱼᵥₗ≧0 where,

ISTᵢ is the threshold impression likelihood score for content item provider (i);

v is the bid value;

αₗ is a discount factor for the content item slot (l);

yᵢⱼᵥₗ is the success probability for the bid value (v) at content item slot (l);

qⱼ is the probability that the next content request (j) is received next;

xᵢⱼ is the conditional probability that content item provider (i) is provided a bid request for the next content request (j);

pᵢ is the maximum rate at which the content item provider (i) is able to receive bid requests; and

pᵢⱼᵥ is the probability (e.g., from a bid distribution) that content item provider (i) submits the bid value (v) for the next content request (j).

In some implementations, the threshold impression likelihood score for each content item provider can be solved simultaneously using a content request data for a set of previously received content requests, and such that the linear program of relationship (4) is maximized.

LP=max ΣⱼqⱼΣᵥΣₜΣᵢαₗyᵢⱼᵥᵢ (4)

such that:

Σⱼqⱼxⱼ≦pᵢ;

ΣᵥΣₜyᵢⱼᵥₗ≦1.0;

xᵢⱼ≦1.0;

Σₗyᵢⱼᵥₗ≦pᵢⱼᵥxᵢⱼ; and

xᵢⱼ, yᵢⱼᵥₗ≧0 where,

v is the bid value;

αₗ is a discount factor for the content item slot (l);

yᵢⱼᵥₗ is the success probability for the bid value (v) at content item slot (l);

qⱼ is the probability that the next content request (j) is received next;

xᵢⱼ is the conditional probability that content item provider (i) is provided a bid request for the next content request (j);

pᵢ is the maximum rate at which the content item provider (i) is able to receive bid requests; and

pᵢⱼᵥ is the probability (e.g., from a bid distribution) that content item provider (i) submits the bid value (v) for the next content request (j).

The content request data that are processed using relationships (3) and (4) can be stored, for example, in a data store such as the advertising data store 119 of FIG. 1. The content request data can include, for example, data specifying, for each previously received content request, the probability with which the content request will be the next content request and/or targeting information that was included in the content request. The quantity of previously received content requests that are represented by the content request data and/or processed using relationship (3) can vary, for example, based on a desired accuracy of the threshold impression likelihood score and the complexity of a function that represents a content request distribution. For example, processing more previously received content requests will provide a more accurate threshold impression likelihood score than that provided by fewer previously received content requests.

The impression likelihood score for each content item provider is compared to the threshold impression likelihood score for the content item provider. When the impression likelihood score meets or exceeds the threshold impression likelihood score, the content item provider is selected as a qualified content item provider for the next content request. When the impression likelihood score does not meet (i.e., is less than) the threshold impression likelihood score, the content item provider is not selected as a qualified content provider for the next content request.

The next content request is received (310). The next content request can be received, for example, in response to a request from a user device for a resource that is provided by a publisher. For example, when the user device requests the resource, code embedded in the resource can cause the user device to request a content item (e.g., an advertisement) from an advertisement distribution system (e.g., advertisement distribution system 110 of FIG. 1). The request for the content item can specify for example, characteristics of the resource (e.g., resource keywords and/or a resource address) with which the content item will be presented, characteristics of the content item slot (e.g., advertisement slot) in which the content item will be presented, and/or a minimum price (i.e., reserve price) that the publisher will accept for presentation of content items with the resource.

In response to receiving the next content request, bids are requested from the qualified content item providers (310). In some implementations, the bids are requested using a bid request that specifies information about the content request (e.g., resource keywords, resource address, and/or reserve price). As described with reference to FIG. 2, the bid request can transmitted to each of the qualified content item providers or a proper subset thereof.

A content item from at least one of the content item providers is provided (312). In some implementations, the content item is provided by providing instruction to the user device specifying, for each content item, a location from which the user device is to receive the content item. For example, the instructions can specify a network location of a content item provider server from which the user device should request the content item. In some implementations, the content item can be directly provided to the user device without requiring the user device to request the content item from another network location.

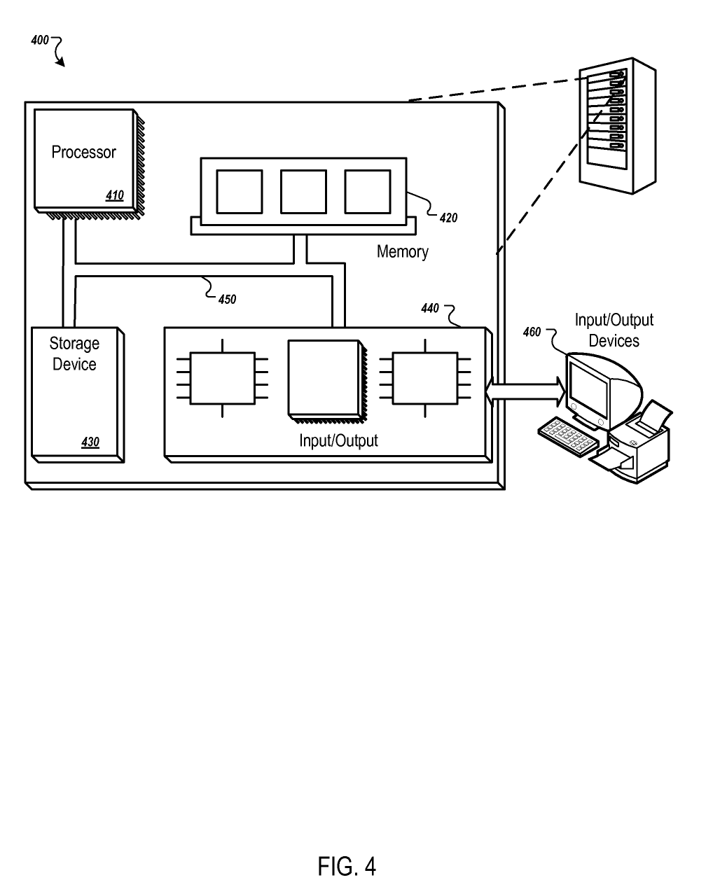

FIG. 4 is block diagram of an example computer system 400 that can be used to selectively request bids from content item providers, as described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
selecting eligible content item providers that are eligible to respond to a next content request, each of the eligible content item providers being selected based, at least in part, on a response constraint that specifies a maximum rate at which the content item provider is able to receive content requests;
determining impression likelihood scores for the eligible content item providers, the impression likelihood score for each of the eligible content item providers specifying a likelihood that a bid received from the eligible content item provider will be a winning bid for the request;
selecting, as qualified content item providers, a set of the eligible content item providers, each of the qualified content item providers having an impression likelihood score that meets a threshold impression likelihood score;
receiving the next content request that requests a content item to be provided with an online resource;
requesting bids from the qualified content item providers in response to the request; and
providing a content item from at least one of the qualified content item providers, the provided content items being selected based, at least in part, on the bids that have been received in response to the request.

2. The method of claim 1, wherein:
selecting the eligible content item providers comprises selecting advertising networks that are eligible to respond to a next advertisement request based, at least in part, on a response constraint that specifies a maximum rate at which the content item provider is able to respond to advertisement requests; and
receiving the next content request comprises receiving the next advertisement request that requests an advertisement to be provided with the online resource.

3. The method of claim 1, wherein selecting eligible content item providers further comprises, for each content provider:
receiving constraint data specifying the response constraint for the content item provider;
determining an actual rate at which bids have previously been requested from the content item provider; and
selecting the content item provider as an eligible content item provider when the actual rate is less than the maximum rate specified by the response constraint.

4. The method of claim 1, further comprising determining a threshold impression likelihood score specifying an impression likelihood score at which a benefit to the content item provider of receiving a bid request for the next content request is substantially equal to an opportunity cost of utilizing bandwidth and other processing resources to process the bid request.

5. The method of claim 1, wherein determining a threshold impression likelihood score comprises determining a different threshold impression likelihood score for each of the qualified content item providers.

6. The method of claim 5, wherein determining an impression likelihood score comprises determining a different impression likelihood score for each of a plurality of different targeting criteria.

7. The method of claim 1, wherein the impression likelihood score is determined for each content item provider based on a function of bid values and a success probability.

8. The method of claim 7, further comprising:
for each content item provider:
receiving historical bid data that specify a bid value distribution for bids that have been received from the content item provider;
receiving a winning bid value distribution specifying likelihoods that bid values will be winning bid values; and
determining a success probability based on a function of the bid value distribution and the winning bid value, wherein
determining the impression likelihood scores comprises determining, for each content item provider, the impression likelihood score for the content item provider based on the success probability and the bid value distribution.

9. The method of claim 1, wherein determining the impression likelihood scores comprises determining the impression likelihood scores on a per-targeting-criterion basis.

10. The method of claim 1, wherein providing a content item from at least one of the qualified content item providers comprises:
receiving bids from the qualified content item providers;
computing auction scores for the qualified content item providers from which bids were received; and
selecting at least one winning content item provider based on the auction scores.

11. A computer storage medium encoded with a computer program, the program comprising instructions that when executed by data processing apparatus cause the data processing apparatus to perform operations comprising:
selecting eligible content item providers that are eligible to respond to a next content request, each of the eligible content item providers being selected based, at least in part, on a response constraint that specifies a maximum rate at which the content item provider is able to receive content requests;
determining impression likelihood scores for the eligible content item providers, the impression likelihood score for each of the eligible content item providers specifying a likelihood that a bid received from the eligible content item provider will be a winning bid for the request;
selecting, as qualified content item providers, a set of the eligible content item providers, each of the qualified content item providers having an impression likelihood score that meets a threshold impression likelihood score;
receiving the next content request that requests a content item to be provided with an online resource;
requesting bids from the qualified content item providers in response to the request; and
providing a content item from at least one of the qualified content item providers, the provided content items being selected based, at least in part, on the bids that have been received in response to the request.

12. A system comprising:
a user device; and
one or more computers operable to interact with the user device and to perform operations including:
selecting eligible content item providers that are eligible to respond to a next content request, each of the eligible content item providers being selected based, at least in part, on a response constraint that specifies a maximum rate at which the content item provider is able to receive content requests;
determining impression likelihood scores for the eligible content item providers, the impression likelihood score for each of the eligible content item providers specifying a likelihood that a bid received from the eligible content item provider will be a winning bid for the request;
selecting, as qualified content item providers, a set of the eligible content item providers, each of the qualified content item providers having an impression likelihood score that meets a threshold impression likelihood score;
receiving the next content request that requests a content item to be provided with an online resource;
requesting bids from the qualified content item providers in response to the request; and
providing a content item from at least one of the qualified content item providers, the provided content items being selected based, at least in part, on the bids that have been received in response to the request.

13. The system of claim 12, wherein the one or more computers are further operable to perform operations including:
selecting advertising networks that are eligible to respond to a next advertisement request based, at least in part, on a response constraint that specifies a maximum rate at which the content item provider is able to respond to advertisement requests; and
receiving the next advertisement request that requests an advertisement to be provided with the online resource.

14. The system of claim 12, wherein the one or more computers are further operable to perform operations including:
for each content item provider:
receiving constraint data specifying the response constraint for the content item provider;
determining an actual rate at which bids have previously been requested from the content item provider; and
selecting the content item provider as an eligible content item provider when the actual rate is less than the maximum rate specified by the response constraint.

15. The system of claim 12, wherein the one or more computers are further operable to perform operations including determining a threshold impression likelihood score specifying an impression likelihood score at which a benefit to the content item provider of receiving a bid request for the next content request is substantially equal to an opportunity cost of utilizing bandwidth and other processing resources to process the bid request.

16. The system of claim 12, wherein the one or more computers are further operable to perform operations including determining a different threshold impression likelihood score for each of the qualified content item providers.

17. The system of claim 16, wherein the one or more computers are further operable to perform operations including determining a different impression likelihood score for each of a plurality of different targeting criteria.

18. The system of claim 12, wherein the impression likelihood score is determined for each content item provider based on a function of bid values and a success probability.

19. The system of claim 18, wherein the one or more computers are further operable to perform operations including:
for each content item provider:
receiving historical bid data that specify a bid value distribution for bids that have been received from the content item provider;
receiving a winning bid value distribution specifying likelihoods that bid values will be winning bid values;
determining a success probability based on a function of the bid value distribution and the winning bid value; and
determining the impression likelihood score for the content item provider based on the success probability and the bid value distribution.

20. The system of claim 12, wherein the one or more computers are further operable to perform operations including determining the impression likelihood scores on a per-targeting-criterion basis.

21. The system of claim 12, wherein the one or more computers are further operable to perform operations including:
receiving bids from the qualified content item providers;
computing auction scores for the qualified content item providers from which bids were received; and
selecting at least one winning content item provider based on the auction scores.
